(19) United States
(12) Patent Application Publication
(10) Pub. No.: US 2013/0224762 A1
(43) Pub. Date: Aug. 29, 2013

(54) MAGNETIC CELL DETECTION

(71) Applicants: Oliver Hayden, Herzogenaurach (DE); Michael Johannes Helou, Regensburg (DE); Sandro Francesco Tedde, Erlangen (DE)

(72) Inventors: Oliver Hayden, Herzogenaurach (DE); Michael Johannes Helou, Regensburg (DE); Sandro Francesco Tedde, Erlangen (DE)

(73) Assignee: SIEMENS AKTIENGESELLSCHAFT, Muenchen (DE)

(21) Appl. No.: 13/883,497

(22) PCT Filed: Oct. 28, 2011
(86) PCT No.: PCT/EP2011/068935

§ 371 Date: May 3, 2013

(30) Foreign Application Priority Data
Nov. 3, 2010 (DE) 10 2010 043 276.8

(51) Int. Cl. G01N 27/72

(52) U.S. Cl. CPC G01N 27/72
USPC 435/7.1; 435/287.2

(57) ABSTRACT

Specific labeling of cells enables magnetic cell detection. The cell type to be detected is labeled, magnetic labels being bound to epitopes of a first cell-specific epitope type via antibodies of a first antibody type. Additionally, second/further magnetic labels are bound to epitopes of a second cell-specific epitope type on the cells via antibodies of a second antibody type, or the magnetic labels are bound to the antibodies of the first antibody type via antibodies of another antibody type and the antibodies of the first antibody type are bound to the epitopes of the first cell-specific epitope type on the cells.

### CROSS REFERENCE TO RELATED APPLICATIONS

This application is the U.S. national stage of International Application No. PCT/EP2011/068935, filed Oct. 28, 2011 and claims the benefit thereof. The International Application claims the benefit of German Application No. 102010043276.8 filed on Nov. 3, 2010, both applications are incorporated by reference herein in their entirety.

### BACKGROUND

Described below is a method and apparatus for magnetic cell detection, where the cells to be detected are labeled using magnetic labels.

In the field of cell detection, flow measurements are known on the one hand. These can be based on magnetic detection, though more commonly on optical measurement methods, for example light scattering spectroscopy or fluorescence spectroscopy. Known on the other hand as detection methods are assays in which a reaction is run in order to detect a specific substance. Various labeling methods are known for both flow cytometry and chemical detection methods. Fluorescent labels, or antigens to be detected, are attached via antibodies to the cells to be detected. In contrast to immunomagnetic detection, as disclosed, for example, by Mujika et al., Phys. Stat. Sol. (a) 205, No. 6, 1478-1483 (2008) “Microsystem for the immunomagnetic detection of Escherichia coli 0157:H7”, in which the substance to be detected is selected by immobilization on a functionalized surface, magnetic flow measurements have greater requirements with respect to the measured signal. Besides the magnetically labeled cells, there is also specifically concomitant flow of unbound labels and agglomerates of unbound labels in the stream and these trigger a signal via the sensor. In addition, the labeling of a cell type is not always unambiguous. Particularly cell types such as tumor cells exhibit a high variance of epitope concentration on the cell surfaces. This therefore gives rise to an entire spectrum of MR signals for one cell type. Magnetic flow cytometry has therefore only been carried out to date with cells which have a high epitope density on the cell surface. In all other cases, it has been necessary to resort to optical flow measurements, which, however, have disadvantages compared to magnetic cell detection in terms of measurement apparatus design.

For a sufficiently high signal-to-noise ratio in detection with magnetoresistive sensors from laminar flow, it is necessary for the cells to be detected to have a high magnetic moment as a result of labeling. The magnetic moment of an individual cell is also critical for in situ accumulation and cell guidance through an external magnetic field.

### SUMMARY

Described below is a method for magnetically detecting and labeling cells which causes the cells to have a sufficiently high magnetic moment. Also described is a suitable measurement device for the method.

The method encompasses magnetic cell detection and specifically labeling of cells. The cells to be detected are assigned to a cell type which has cell-specific epitopes on the surface of the cells. The magnetic labels are attached via antibodies to the epitopes on the surface of the cells. For specific labeling, the magnetic labels are attached via antibodies of a first antibody type, which attach to epitopes of a first cell-specific epitope type. In addition, further magnetic labels are attached via antibodies of a second antibody type to epitopes of a second cell-specific epitope type on the cells. Alternatively, the magnetic labels are attached via antibodies of a fourth antibody type to the antibodies of the first antibody type and these in turn are attached to the epitopes of the first cell-specific epitope type on the cells.

These methods allow specific labeling of cells. As a result of the labeling, the magnetic moment with respect to other cells is increased. In the case of the additional magnetic labels which are attached via a second antibody type, the magnetic label density around the cell is increased, and this occurs only for cells having a combination of a first and a second epitope type. Such labeling thus excludes false-positive signals resulting from other cells which have, for example, only the first epitope type or only the second epitope type. The magnetic moment thereof would thus be very much lower, since only the labels having the first antibody type or only the labels having the second antibody type can attach to these cells.

Alternatively, the selectivity of labeling is increased by a further fit taking place via the combination of a fourth antibody type with the first antibody type. In particular, the first antibody type is a highly specific antibody type which attaches to the epitopes of the cell. The highly specific antibody type ensures, for example, a very low number of false attachments. The magnetic labeling can then, for example, be achieved via a less specific fourth antibody type. The recognition of the first antibody type is less error-prone than the recognition of the cell-specific epitopes on the surface.

The labeling according to the method makes calibration-free magnetic flow cytometry possible.

In an advantageous embodiment, the magnetic moment of the cells is increased in the method by additionally attaching magnetic labels via antibodies of a third antibody type to epitopes of a third cell-specific epitope type on the cells. This has the advantage of performing further selection with respect to cells also exhibiting a combination of epitopes of the first and the second epitope type and differing from the cells to be detected only in epitopes of a third epitope type.

Moreover, the magnetic moment of the cells is increased as a result of the higher label density on the cell surface. This makes it possible to set a higher threshold value for a positive signal.

In a further advantageous embodiment, the second and/or the third antibody type is chosen in the method such that it does not attach to epitopes on a second cell type. Alternatively, the second and/or the third antibody type is chosen such that it only attaches to epitopes which do not occur in the same concentration as on the cell type to be detected. Thus, the choice of antibodies makes it possible to achieve selection that ensures a virtually exclusive detection of cells of the cell type to be detected.

In particular, it is possible to achieve immunomagnetic labeling with multiple antibodies against various epitopes on a cell in order to prevent cross-selectivities with respect to other cells with lower epitope density.

In an advantageous embodiment, the magnetic moment of the cells is increased in the method by attaching, in a second labeling, additional magnetic labels via antibodies of a fourth antibody type to the magnetic labels of the first labeling. The label density can thus also be increased as a result of second labeling of the magnetic beads already attached to the cell. To this end, the antibodies of the fourth antibody type must specifically bind the magnetic bead of the first labeling. In particular, the additional magnetic labels are different from the magnetic labels of the first labeling. Thus, the label concentration around the cell and hence the magnetic moment of the cell is significantly increased. Thus, the magnetoresistive signal produced by the individual cell is increased and ensures a high signal-to-noise ratio.

In the method for magnetic cell detection, the specifically magnetically labeled cells are expediently recorded via a magnetoresistance change. The high magnetic moment of the cells ensures in particular that a lower threshold value for a magnetoresistance change can be set at a sufficiently high level for the signal-to-noise ratio to be at least two. In particular, the signal-to-noise ratio is at least three.

In a further advantageous embodiment, an upper threshold value for a magnetoresistance change is set in the method at a sufficiently low level for single-cell detection to be achieved. This has the advantage that higher values with respect to magnetoresistance change are not assigned to individual cells but to agglomerates and are ruled out as false-positive signals.

In a further advantageous embodiment, magnetic detection is achieved by flow cytometry. In this case, the specifically labeled cells are recorded in particular during flow across a sensor. For example, the cells are guided in laminar flow. An example of the advantage of flow cytometry is high sample throughput.

In a further advantageous embodiment, the method uses magnetic labels, the diameter of which is less than 200 nm. The advantage of the small size of the magnetic labels, also known as magnetic beads, is that agglomerates do not form, these arising because of the attachment of a multiplicity of antibodies to a large single magnetic label. The small magnetic labels having diameters of less than 200 nm can be arranged individually around the cells.

In a further advantageous embodiment, the method uses superparamagnetic magnetic labels. These have an advantage over, for example, ferromagnetic beads with respect to recordability via magnetoresistive components.

In a further advantageous embodiment, the cells are guided in the method in a gradient magnetic field and thereby accumulated on the sensor. A gradient magnetic field makes it possible to specifically steer the magnetically labeled cells across the sensor.

The device for magnetic cell detection has a sensor and an analysis unit. The analysis unit and the sensor are designed such that a spectrum of magnetoresistance changes can be captured. In this case, the analysis unit is provided with a lower threshold value for a magnetoresistance change that is at a sufficiently high level for the signal-to-noise ratio to be at least three. Additionally or alternatively, an upper threshold value for a magnetoresistance change is provided that is at a sufficiently low level for it to be possible to carry out single-cell detection. The combination of both threshold values is particularly advantageous for high measurement specificity.

A positive MR signal from an individual cell must be able to stand out from background effects, for example unbound labels, aggregated labels or other magnetic interference fields. Thus, an individual cell must attain a magnetoresistance change that is above a threshold value in order to hide such background effects. In addition, an upper threshold value can also be set in order to rule out the possibility of, for example, labeled cell aggregates or larger aggregates of magnetic labels being concomitantly counted.

In an advantageous embodiment, the device includes a flow-guidance system which makes the device suitable for magnetic flow cytometry. Furthermore, the device produces a gradient magnetic field in the flow-guidance system. As a result, it is possible for magnetically labeled cells to accumulate on the sensor in the gradient magnetic field. Accordingly, the device is designed for producing the gradient magnetic field, e.g., using ferromagnetic strips.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic diagram illustrating onefold magnetic labeling of a cell A.

FIG. 2 is a schematic diagram illustrating twofold magnetic labeling of a cell A.

FIG. 3 is a graph of the distribution of cells A with regard to the magnetoresistance change that they have produced.

FIG. 4 is a schematic diagram illustrating a magnetically labeled cell B/C.

FIG. 5 is a graph of the distributions of cells A, B and C with regard to the magnetoresistance changes that they have produced.

FIG. 6 is a schematic diagram illustrating a twofold magnetically labeled cell A with different magnetic labels.

FIG. 7 is a schematic diagram illustrating a specifically labeled cell A.

FIG. 8 is a schematic diagram illustrating a specifically labeled cell A with twofold labeling as a result of different magnetic labels.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

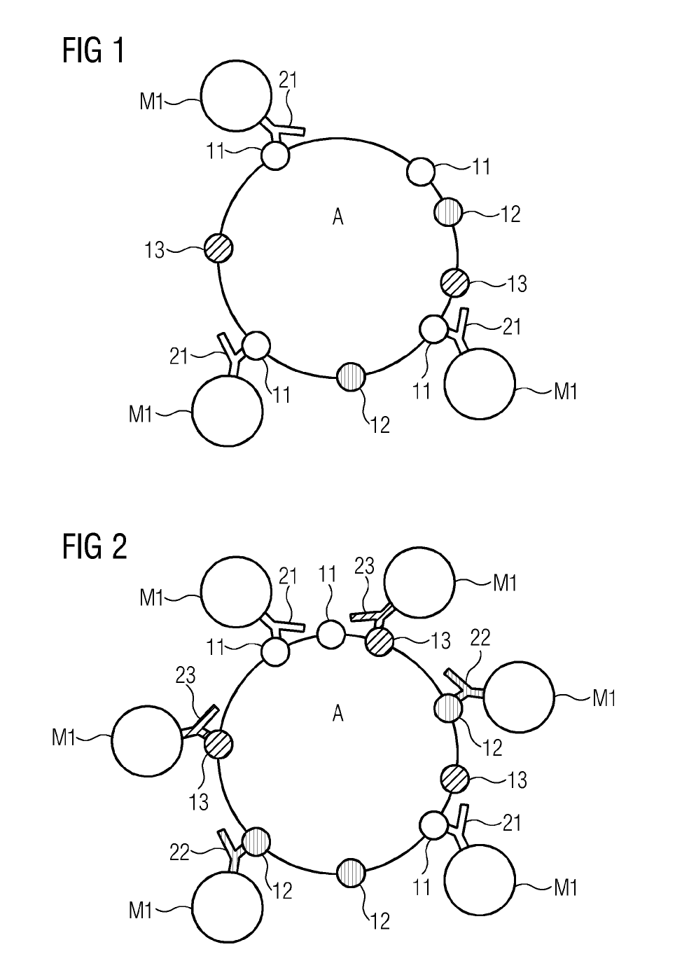

FIGS. 1, 2, 4 and 6 to 8 each show diagrams of cells A, B, C, which have epitopes 11, 12, 13 on the surface. The cell surface is shown as a large circle. Attached to epitopes 11, 12, 13, which are shown as small circles, are antibodies 21, 22, 23, 24, which are Y-shaped in the diagrams. In each case, one end attaches to an epitope 11, 12, 13 on the cell surface and another end attaches to a magnetic label M1, M2. Magnetic labels M1, M2 are shown as circles which are larger than epitopes 11, 12, 13. However, magnetic labels M1, M2 have diameters which are very much smaller than cells A, B, C. Although the figures are not drawn to scale, the proportion shown of magnetic labels M1, M2 with respect to cells A, B, C is correct. In the case of larger magnetic labels M1, M2, aggregation and crosslinking would occur. This means that multiple antibodies 21, 22, 23, 24 would be arranged around one magnetic label M1, M2 and attach to the label, and the individual cell A, B, C would therefore no longer be labeled, but instead an agglomerate of antibodies 21, 22, 23, 24, cells A, B, C and magnetic labels M1, M2 around a very large magnetic label would be produced.

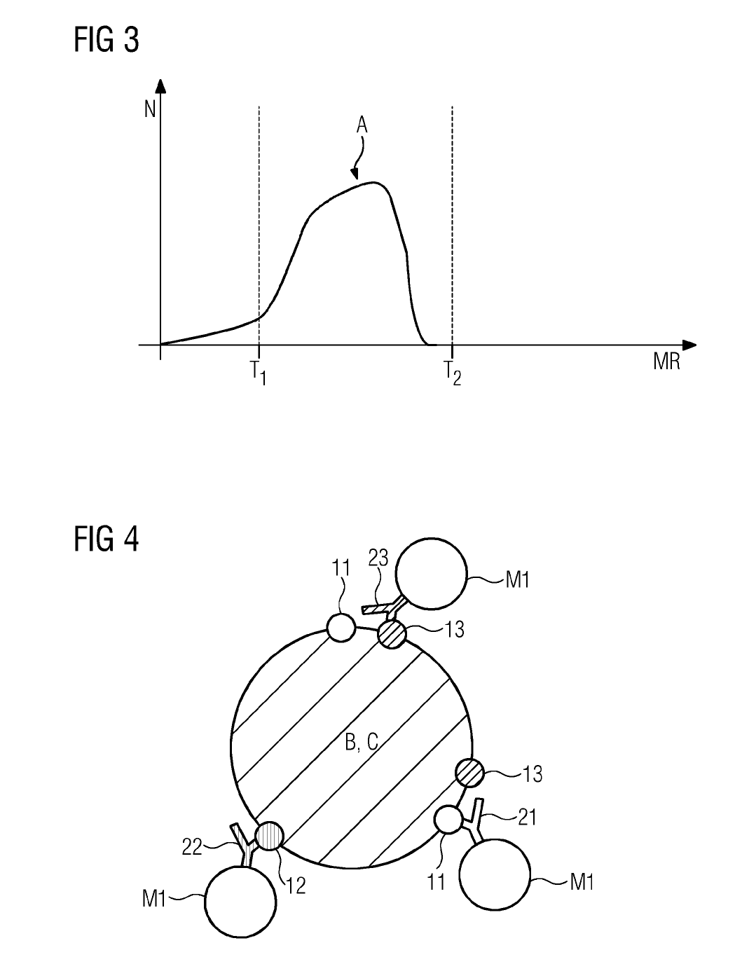

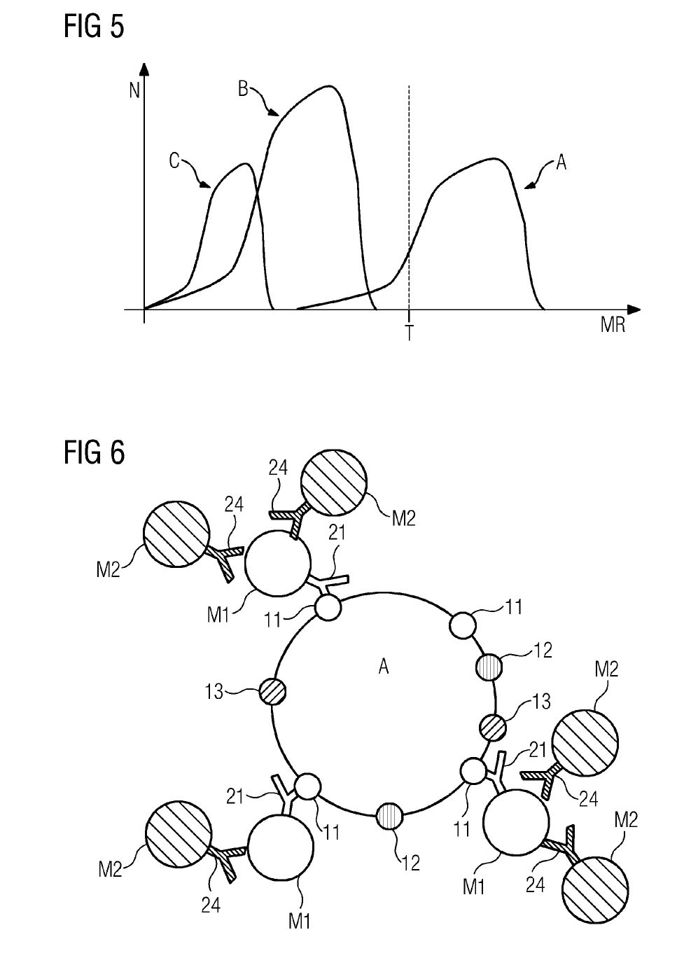

FIGS. 3 and 5 each show a graph in which magnetoresistance change MR is plotted against the number of cells N, which produce the MR signal. FIG. 3 shows the distribution of cells A, and FIG. 5 shows the distributions of cells A, B and C. In the latter case, cells A produce a very much higher MR signal than cells B, and cells B produce a higher signal than cells C. However, there are also, in each case, overlapping regions in which it is not possible to distinguish which of cell types A, B, C is producing the MR signal. Threshold values T for the MR signal are therefore set on the basis of values from past experience or on the basis of known distributions. The threshold value T is then used to distinguish between positive and negative results. In the graph in FIG. 3, an upper T₂ threshold value and a lower T₁ threshold value are set. Above the lower threshold value T₁, an MR signal is classified as a positive signal. Below the upper threshold value T₂, single-cell detection is assumed. Agglomerates in particular would produce a very much higher MR signal.

FIG. 1 shows first of all the simplest form of magnetic labeling. A cell A has a multiplicity of epitopes 11, 12, 13 on the cell surface. The number of one epitope type can encompass about 500 epitopes on a cell. When labeling using an antibody 21, 22, 23, 24 which attaches to a specific epitope type 11, 12, 13, about 80% of the epitopes are covered. This means that there are free characteristic epitopes 11, 12, 13 which could still capture a magnetic label M1, M2 via a specific antibody 21, 22, 23, 24. Such labeling is not sufficient for a useful signal. This means that labels M1, M2 attached onto cell A, B, C via only one antibody type 21-24 do not sufficiently increase the magnetic moment of cell A, B, C for a sufficiently high MR signal to be produced. This means that the ratio of signal to noise, owing to unbound magnetic labels M1, M2 for example, is not sufficient for an unambiguous positive signal. This means that the sensitivity of labeling is too low. Moreover, the selectivity of labeling is also too low. A cell B differs from a cell A in the number and type of epitopes 11, 12, 13 on the surface. However, there may also be the possibility of an antibody 21-24 wrongly attaching to epitopes 11-13. It is also possible for cells A, B to differ, but to closely match exactly in the epitope to be labeled, epitope 11. For example, cell A and cell B share only one common epitope type, epitope 11, which, however, is present in approximately the same concentration on the cell surface. Therefore, cell B is labeled in equal measure by labels M1 featuring antibody 21 and cannot be distinguished from cell A in the measurement.

FIG. 2 shows in turn a cell A which, however, is now labeled via multiple different antibody types 21, 22, 23. Magnetic labels M1 featuring different antibodies 21, 22, 23 are provided. These attach to epitopes 11, 12, 13 on the cell surface. First of all, this increases the magnetic moment of cell A by doubling or tripling the number of labels M1 around cell A, i.e., sensitivity is increased. Therefore, as shown in FIG. 5, the MR signal of cells A can be distinctly increased over the MR signals of cells B or C and thus stand out from the signals of cells B and C by a threshold level T. Furthermore, increased selectivity is therefore also achieved. Although cells B and C may possibly have a similar number of the first epitope type 11, cells B and C do not have the second and the third labeled epitope type 12, 13 or they have them in a very much lower concentration than cell A.

FIG. 6 shows in turn a cell A having epitopes 11, 12, 13 on the cell surface, which distinguish cell A from cells B, C. Magnetic labeling is carried out first by the attachment of magnetic labels M1 via antibodies 21 to epitopes 11. A second labeling is carried out in this case not by a second epitope type, but by additional labels M2 featuring antibodies 24, which in turn attach to magnetic labels M1. The magnetic moment of cell A is therefore increased. Selectivity is achieved by the antibody-epitope pair 21-11. The attachment of additional magnetic labels M2 is very much better than the use of larger magnetic labels. When label diameter or volume is increased, agglomeration effects are intensified. On a large magnetic label of over 200 nm in diameter, there is attachment of multiple antibodies, which then crosslink cells A, B, C and magnetic labels M1, M2. Ideally, superparamagnetic particles having a diameter of <200 nm are used for magnetic labeling.

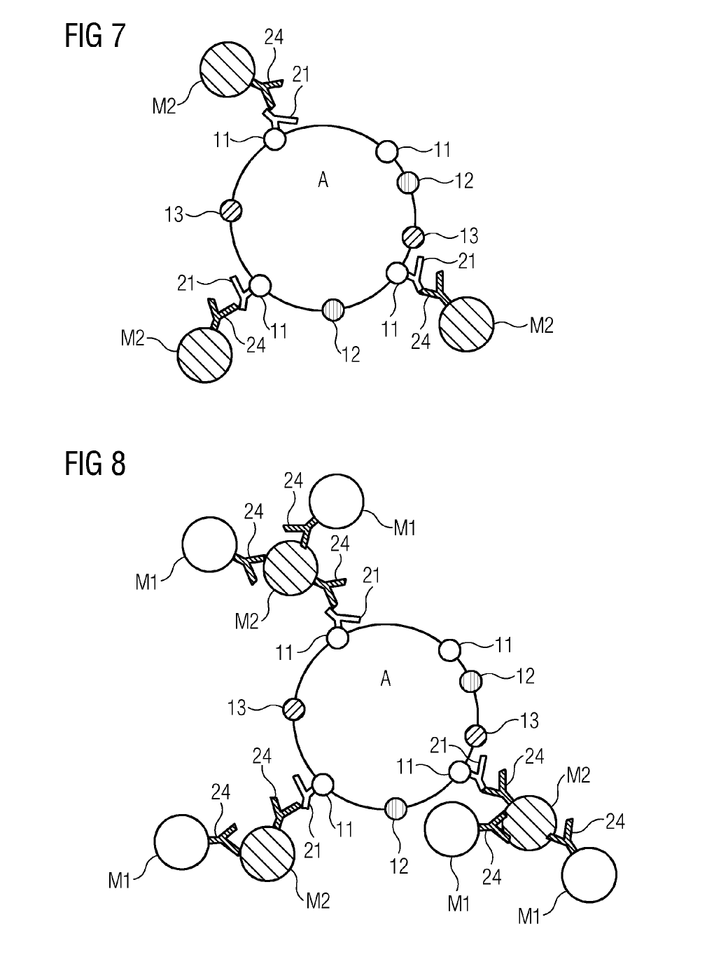

FIG. 7 shows a further way of increasing the selectivity of labeling. In this case, the epitopes of a first epitope type 11 on the surface of cell A are first labeled with matching antibodies 21. Attached in turn to the antibodies 21 are antibodies 24. The antibodies 24 are joined to magnetic labels M2. Although the magnetic moment is not thereby increased compared to labeling as in FIG. 1, attachment is very much more specific via the combination of two antibodies 21, 24, and this increases the selectivity of the MR measurement. To increase sensitivity, i.e., to achieve a better signal-to-noise ratio, it is possible to carry out again a kind of sandwich labeling, as already shown in FIG. 6. This combination is shown in FIG. 8. In this case, the first magnetic labeling, via labels M2 featuring antibodies 24, to specific antibody 21 is carried out to achieve high selectivity. The magnetic moment is then increased by second labeling by labels M1 via antibodies 24, which attach to magnetic labels M2. The labeling may be carried out in two successive labeling operations.

An exemplary magnetic flow cytometry run is described below. In particular, this is carried out in a microfluidic device. Three operations are essential for efficient measurement:
1. in situ accumulation of magnetically labeled cells A on the sensor,
2. cell guidance, in particular guidance of magnetically labeled cells A in flow across the sensor, and
3. detection of magnetically labeled cells A by a magnetoresistive component.

Cell transport, i.e., cell flow through the microfluidic device, is carried out in particular in laminar flow. Magnetically labeled cells A experience in addition a force in an external magnetic gradient field. The gradient field is adjusted such that cells A are taken past the sensor, which, for example, is mounted on or in the channel wall. To achieve in situ accumulation and cell guidance, it is necessary for magnetically labeled cells A to have a sufficiently high magnetic moment. Only then is it possible for them to be influenced and steered in the external magnetic gradient field. The external magnetic gradient field is, for example, 100 mT or a value in this order of magnitude. To achieve detection of cells A having a magnetoresistive component, it is necessary for magnetically labeled cells A to have a high stray field. Only when magnetically labeled cells A have a sufficiently high stray field do they bring about a sufficiently large resistance change MR in the component.

The method described above makes it possible, irrespective of the epitope concentration per cell surface, to label cells A, B, C such that magnetic flow cytometry can be carried out. The epitope concentration per cell surface is typically 1000 or more. In the method, superparamagnetic particles are used in particular for labeling and are arranged on the cell surface at a sufficient density for the magnetic moment, irrespective of cell type and epitope density thereof, to be suitable for magnetic flow cytometry. The high label density and the resulting high magnetoresistive signal MR make it possible to set a sufficiently high threshold value T for a positive signal in order to exclude background effects which might otherwise be recorded as false-positive signals. In particular, combined immunomagnetic labeling can be carried out. This allows cell accumulation even in media such as, for example, whole blood and cell guidance in a gradient field. The gradient field can be produced in particular by ferromagnetic strips, which can be arranged around the microfluidic device.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-14. (canceled)

15. A method for magnetic cell detection, comprising:
attaching first magnetic labels via antibodies of a first antibody type to epitopes of a first cell-specific epitope type to specifically label cells of a first cell type to be detected; and
attaching additional magnetic labels to the cells of the first cell type by at least one of
attaching second magnetic labels via antibodies of a second antibody type to epitopes of a second cell-specific epitope type on the cells; and
attaching third magnetic labels via antibodies of a third antibody type to the antibodies of the first antibody type prior to attaching the antibodies of the first antibody type to the epitopes of the first cell-specific epitope type on the cells.

16. The method as claimed in claim 15, further comprising attaching fourth magnetic labels via antibodies of a fourth antibody type to epitopes of a fourth cell-specific epitope type on the cells, thereby increasing a magnetic moment of the cells.

17. The method as claimed in claim 16, wherein at least one of the second antibody type and the fourth antibody type does not attach to epitopes on a second cell type or only attaches to epitopes which do not occur in a same concentration as on the first cell type.

18. The method as claimed in claim 17, further comprising attaching fifth magnetic labels, which are different from the first magnetic labels, via antibodies of the third antibody type, thereby further increasing the magnetic moment of the cells.

19. The method as claimed in claim 18, further comprising recording the specifically magnetically labeled cells via a magnetoresistance change.

20. The method as claimed in claim 19, wherein said recording of the specifically labeled cells uses a lower threshold value for the magnetoresistance change set at a sufficiently high level for a signal-to-noise ratio to be at least 3.

21. The method as claimed in claim 20, wherein said recording of the specifically labeled cells uses an upper threshold value for the magnetoresistance change set at a sufficiently low level for single-cell detection to be achieved.

22. The method as claimed in claim 21, wherein said recording of the specifically labeled cells is during laminar flow across a sensor in magnetic flow cytometry.

23. The method as claimed in claim 22, wherein all of the magnetic labels have diameters of less than 200 nm

24. The method as claimed in claim 23, wherein all of the magnetic labels are superparamagnetic.

25. The method as claimed in claim 24, further comprising:
guiding the cells in a gradient magnetic field; and
accumulating the cells on the sensor.

26. A device for magnetic cell detection, comprising:
a sensor configured to detect a spectrum of magnetoresistance changes; and
an analysis unit, coupled to the sensor, configured to capture the spectrum of magnetoresistance changes detected by the sensor based on at least one of a lower threshold value for a magnetoresistance change that is at a sufficiently high level for the signal-to-noise ratio to be at least 3 and an upper threshold value for the magnetoresistance change that is at a sufficiently low level to carry out single-cell detection.

27. The device as claimed in claim 26 further comprising:
a flow-guidance system in magnetic flow cytometry; and
means for producing a gradient magnetic field in the flow-guidance system and accumulating magnetically labeled cells on the sensor by the gradient magnetic field.

28. The device as claimed in claim 27, wherein the means for producing the gradient magnetic field includes ferromagnetic strips.
